(19) United States
(12) Patent Application Publication
(10) Pub. No.: US 2016/0334787 A1
(43) Pub. Date: Nov. 17, 2016

(54) MULTI-AGENT DEPLOYMENT PROTOCOL METHOD FOR COVERAGE OF CLUTTERED SPACES

(71) Applicant: KING FAHD UNIVERSITY OF PETROLEUM AND MINERALS, Dhahran (SA)

(72) Inventor: AHMAD A. MASOUD, DHAHRAN (SA)

(21) Appl. No.: 14/712,879

(22) Filed: May 14, 2015

(51) Int. Cl. G05D 1/00

(52) U.S. Cl. CPC G05D 1/0027; G05D 1/0088; Y10S 901/01; Y10S 901/08; G05D 2201/0207

(57) ABSTRACT

The multi-agent deployment protocol method for the coverage of cluttered spaces is a sensor-based control protocol, which, if used by each member of the group, will cause the collective group to distribute itself in the environment in a manner that satisfies stringent requirements, including the requirement that the systems should be self-deploying and self-maintaining, robust and resilient, while tolerating the loss or insertion of agents. The group members must also be able to figure-out on their own where the best coverage locations are and how to reach them from anywhere in space without self-collision or collision with obstacles. Overall, the autonomous process performs the following functions: determine where the agents should be positioned (i.e., location); propel each agent to its corresponding target location; and organize the overall space to avoid collisions or deadlocks.

### BACKGROUND OF THE INVENTION

1. Field of the Invention

The present invention relates to robotics, and particularly to a multi-agent deployment protocol method for coverage of cluttered spaces.

2. Description of the Related Art

There is a growing demand to use mobile agents in large cluttered areas for such applications as monitoring free space or functioning as communication relays. In many of these cases, the agents are spatially distributed so that their line of sight covers as much free space as possible. They must be robust and resilient tolerating the loss or insertion of agents.

The group members must also be able to figure-out on their own where the best coverage locations are and how to reach them from anywhere in space without self-collision or collision with obstacles. There are stringent requirements on such systems to be practical. For example, the systems should be self-deploying and self-maintaining.

Thus, a multi-agent deployment protocol method for coverage of cluttered spaces solving the aforementioned problems is desired.

### SUMMARY OF THE INVENTION

The multi-agent deployment protocol method for coverage of cluttered spaces provides a sensor-based control protocol, which, if used by each member of the group, will cause the collective group to distribute itself in the environment in a manner that satisfies stringent requirements, including the requirement that the systems should be self-deploying and self-maintaining, robust and resilient, while tolerating the loss or insertion of agents. The group members must also be able to figure-out on their own where the best coverage locations are and how to reach them from anywhere in space without self-collision or collision with obstacles.

These and other features of the present invention will become readily apparent upon further review of the following specification and drawings.

### BRIEF DESCRIPTION OF THE DRAWINGS

FIG. 1A is a block diagram of a control protocol used to generate robotic motion according to the present invention.

FIG. 1B is a schematic diagram showing initial conditions under the control protocol used to generate robotic motion according to the present invention.

FIG. 1C is a schematic diagram showing final conditions under the control protocol used to generate robotic motion according to the present invention.

FIG. 2 is a block diagram showing multiple agents operating in a cluttered environment while using the control protocol used to generate robotic motion according to the present invention.

FIG. 3 is a flowchart showing processing using the control protocol used to generate robotic motion according to the present invention.

FIG. 4 is a plot showing scalar field generation for an environment with a convex square obstacle.

FIG. 5 is a plot showing guidance field generation for an environment with a convex square obstacle.

FIG. 6A is a plot showing trajectories of four agents running the protocol according to the present invention.

FIG. 6B is a plot showing the minimum inter-agent distance versus time of the four agents running the protocol according to the present invention.

FIG. 7A is a plot showing initial positions of four fully-communicating agents in a non-convex environment according to the present invention.

FIG. 7B is a plot showing final positions of four fully communicating agents in a non-convex environment according to the present invention.

FIG. 8 is a plot showing trajectories corresponding to FIG. 7A and FIG. 7B linking start points with end points according to the present invention.

FIG. 9A is a plot showing initial positions of four agents, each communicating with only its nearest neighbor in a non-convex environment according to the present invention.

FIG. 9B is a plot showing final positions of four agents, each communicating with only its nearest neighbor in a non-convex environment according to the present invention.

FIG. 10 is a plot showing trajectories corresponding to FIGS. 9A and 9B linking start points with end points according to the present invention.

Similar reference characters denote corresponding features consistently throughout the attached drawings.

### DETAILED DESCRIPTION OF THE PREFERRED EMBODIMENTS

The multi-agent deployment protocol method for the coverage of cluttered spaces provides a sensor-based control protocol, which, if used by each member of the group, will cause the collective group to distribute itself in the environment in a manner that satisfies stringent requirements, including the requirement that the systems should be self-deploying and self-maintaining, robust and resilient, while tolerating the loss or insertion of agents. The group members must also be able to determine on their own where the best coverage locations are and how to reach them from anywhere in space without self-collision or collision with obstacles. The present multi-agent deployment protocol method provides steering control in such an environment, where collectively the agents have line-of-sight coverage of most of the environment. The method operates on-line (i.e., onboard each agent) and is sensor-based, with no centralized or “leader” agent controlling overall steering for the group. Each agent senses both obstacles in its local environment, as well as the position of the nearest other agents. Steering control is then governed by a potential field scheme with relaxation.

The proposed process functions to deploy a group of agents from anywhere in cluttered space so that they are positioned at locations where they have a line of sight coverage of most, if not all, of free space. This process is important in applications like surveillance and communication coverage among others. In doing this, the process must autonomously (i.e., without operator intervention) perform functions, such as determining the locations where are the agents should be positioned; propelling each agent to its corresponding target point; and deconflicting the use of space so that no collision or deadlock will occur.

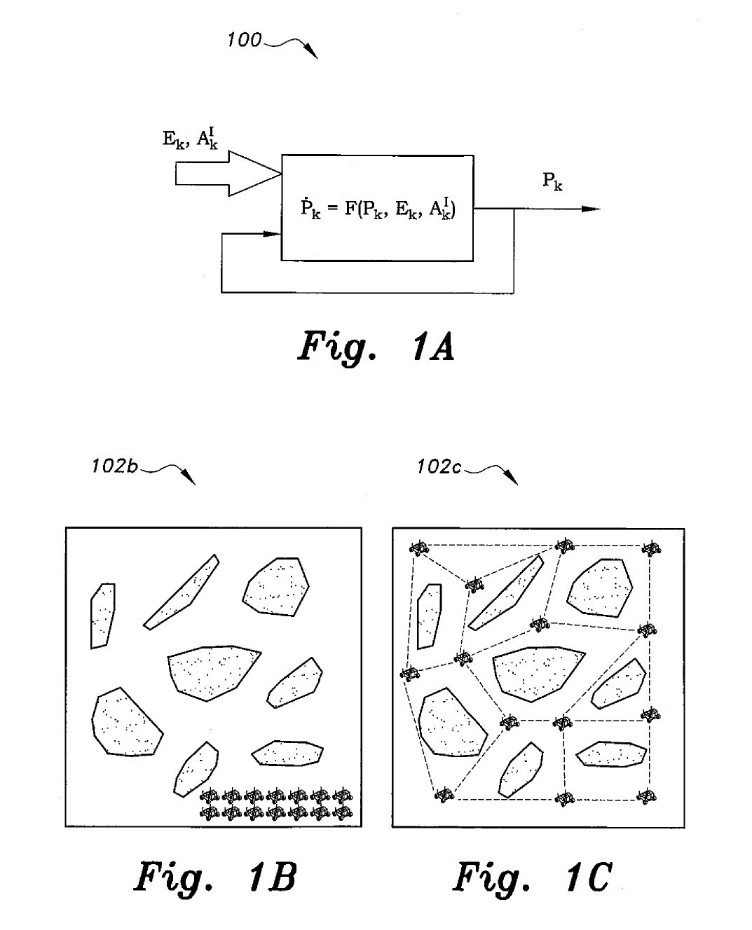

The issue solved is the steering of a group of mobile agents in a cluttered space to locations where collectively the agents have line of sight coverage of most of the environment. Each agent functions under the control law 100 shown in FIG. 1A. FIG. 1B shows initial positions 102b of the agents. The feedback control law 100 is characterized by the relation:

\dot{P}ₖ=F(Pₖ,Eₖ,Aₖ^{I}) (1)

where \dot{P}ₖ is the time derivative of Pₖ, the position of the k^{th} agent in 2D space; Eₖ is the environment description available to the k^{th} agent; and Aₖ^{I} is a set containing the positions of the nearest Lₖ agents ordered according to their distance from agent k.

FIG. 1C shows the final positions 102c of the agents while performing under control law 100. The steering effort has to be carried-out in an on-line, sensor-based manner. In other words, the target locations the agents have to move to in order to obtain good environmental coverage are not provided to these agents. The agents themselves have to generate these goal points online while attempting to reach them. Moreover, the agents are not labeled, nor are they required to know all the team members. The suggested scheme is designed to work even if each agent is restricted to know the position of its nearest neighbor. Moreover, the scheme is leaderless and self-organizing, with no central entity regulating the behavior of the agents. The above two restrictions on operation make it possible for any agent to join or leave the group with minimal disruption to the function the collective is required to carry out.

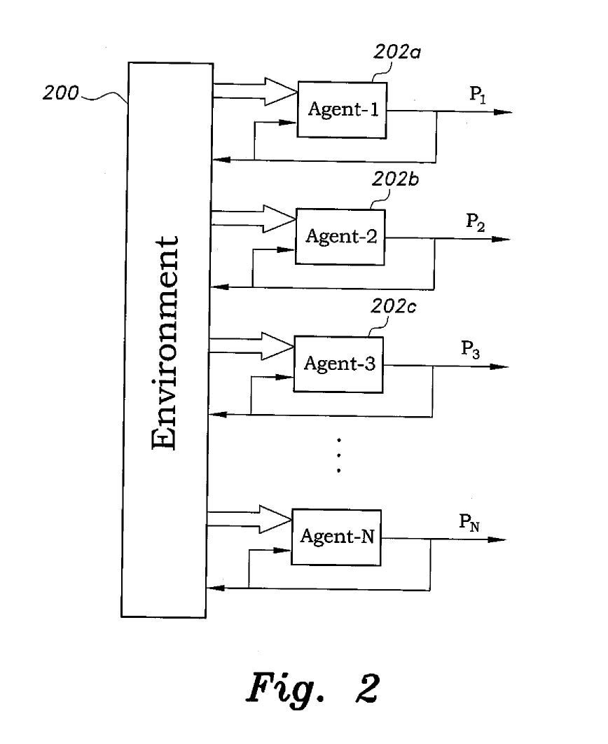

The above is achieved by utilizing a steering control protocol (comprising control law 100, shown in FIG. 1A), which each member of the group has to use. As shown in FIG. 2, the agents, including first, second, and third agents 202a, 202b and 202c interact with environment 200, each agent utilizing the output Pₖ of the control law 100. The agents do not have a rigid relation to each other. Rather, they observe the components of their environment, whether the components are obstacles or other agents. These observations are fed to the protocol for execution of the control law 100 in order for each agent to generate a self-directed motion within the environment 200. Thus, there is no direct exchange of information among the agents. Information is implicitly exchanged through observation of the environment. A provably correct group behavior emerges from the protocol-regulated interaction of the agents among themselves and with the obstacles in their environment.

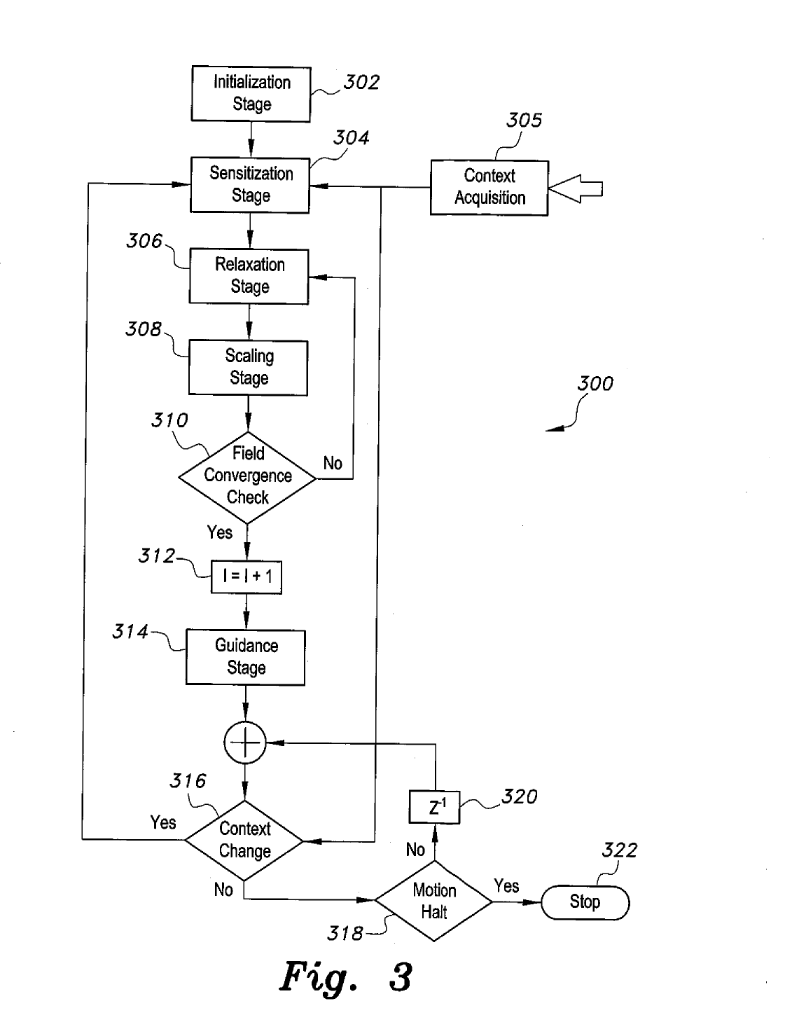

The protocol work flow 300 is shown in FIG. 3. As shown, there is an initialization stage 302, followed by a sensitization stage 304. In addition to initialization stage 302, context acquisition 305 is fed as input to the sensitization stage 304. The relaxation stage 305 accepts input from the sensitization stage 304 and outputs to the scaling stage 308. If the field has not converged for a solution according to field convergence check 310, the relaxation stage 306 is repetitively executed. If the field has converged, a counter is incremented at step 312, and guidance stage 314 is executed and summed with its previous state Z⁻¹ from step 320. If the sum has produced a context change at step 316, then all previous steps beginning at the sensitization stage 304 are re-executed. If there is no context change, as determined by step 316, and if the agent has not halted, as determined at step 318, then a historical guidance stage is recorded at step 320 for comparison with updated guidance commands from guidance stage 314. Otherwise, the agent is commanded to halt at step 322.

Table 1 presents symbols and abbreviations used to describe modules of the protocol.

TABLE 1
Glossary of Symbols and Abbreviations

| Symbol | Definition |
|---|---|
| i, j: | the index of x and y components of space respectively |
| | (x = i · Δx), (y = i · Δy) where Δx and Δy are the |
| | discretization steps, i = 1, . . . , N, j = 1, . . . M |
| SE | Subjective environment created by the sensory signal and |
| | used to synthesize the motion of the robot |
| xo, yo | are coordinates of the initial position of an agent |
| k: | the index of the k'th agent |
| Pₖ: | the position of the k'th agent in 2D space Pₖ = [xₖ yₖ]^{T} |
| DPₖ: | the discretized position Pₖ |
| I: | an index indicating the number of times an agent reacted to |
| | changes in its environment |
| DSE: | Matrix with N × N elements representing the discrete SE |
| s: | speed at which an agent is required to move |
| Vₖ^{I}(i, j): | a matrix covering the space agent k is working in. It is used |
| | in synthesizing the guidance signal for the agent |
| Vm | the minimum of Vₖ^{I}(i, j) |
| Q(i, j): | a temporary variable used to checking convergence of |
| | Vₖ^{I}(i, j) |
| Gₖ^{I}(i, j): | a matrix used store the guidance vector at each point in |
| | agent's space Gₖ^{I} = [Gxₖ^{I} Gyₖ^{I}]^{T} |
| Aₖ^{I}: | A set containing the positions of the nearest Lₖ agents |
| | ordered according to their distance from agent k. The set is |
| | available to agent k at the I^{th} interaction with |
| | the environment (Aₖ^{I} = {Pₘ: m = 1 . . . Lₖ}) |
| Eₖ^{I}(i, j): | The environment description available to the k'th agent at |
| | interaction instant I. An entry = 1 indicates an obstacle. An |
| | entry = 0 indicate free space |
| ε₁, ε₂ | are arbitrarily small positive constants used with the |
| | convergence criterion |

The present method can position the agents in locations where most free space is covered by the group's line of sight. The procedure is a deployer. In other words, it not only locates the position of the most space coverage points, it also can move the agents from anywhere in space to these locations. The procedure is decentralized and self-organizing, making it highly robust and resistant to failure. The procedure does not assume an a priori fixed number of agents in order to function. It allows any agent to leave or enter the scene with minimal adjustment. The procedure can operate without the need to label agents. The procedure is scalable, and admits a large number of agents.

The procedure functions in 2D as well as 3D cluttered spaces. The procedure can distribute the agents in arbitrary clutter, irrespective of its geometry or topology. The guidance signal from the procedure is control friendly and can be converted in a provably correct manner to a control signal that guides sophisticated agents, such as robots or UAVs. The procedure works very well, even if data exchange among the agents is limited to only their nearest neighbors. The procedure guarantees that the agents will not collide with the obstacles of the environment or with each other during motion towards their respective target. The procedure is mathematically correct. The procedure may be executed in a real-time, sensor-based manner. The area coverage final positions selected by the present method are safely situated away from the obstacles.

The protocol 300 turns the individuals into an autonomous, goal-oriented group capable on its own to perform the function of moving to the a priori unknown locations in a cluttered environment, where most visibility by the group is attained. The group is self-motivated, self-guided, self-organized and self-deployed. The group can find, on its own, where the positions of maximum environmental visibility are. The group can generate, on its own, a trajectory for each agent that allows the agent to reach its maximum visibility target point from anywhere in the environment. The group can de-conflict the use of the environment for motion, in essence, generating a safe path for each agent to its target that avoids collision with the obstacles and collision with the team members. Below is a detailed description of each module in the protocol. Table 2 shows the initialization stage 302.

TABLE 2
Steps of the Initialization Stage

| INIT | |
|---|---|
| STEP | Function |
| 1 | Set boundaries of the zone in which the agent is allowed to |
| | operate by setting Δx and Δy and computing N and M |
| 2 | Set I = 0 |
| 3 | Set desired speed of the agent (S) |
| 4 | Set Vₖ^{I}(i, j) = 0.5 ∀i, j |
| 5 | Set Vₖ^{I}(i, 0) = 1, Vₖ^{I}(i, M) = 1 i = 1, . . . N, |
| 6 | Set initial location of agent xₖ = xo, yₖ = yo |

Table 3 shows the context acquisition stage 305.

TABLE 3
Steps of the Context Acquisition Stage

| CA | |
|---|---|
| STEP | Function |
| 1 | Sense the obstacles in the environment (i.e. obtain Eₖ^{I}(i, j)) |
| 2 | Determine the positions of the Lₖ nearest agents (i.e. obtain Aₖ^{I}) |

Table 4 shows the sensitization stage 304.

TABLE 4
Steps of the Sensitization Stage

| SENS | |
|---|---|
| STEP | Function |
| 1 | convert Aₖ^{I} into a discrete position index set |
| | DAₖ^{I} = {DPₘ: m = 1 . . . , Lₖ} |
| | where DPₘ = [Iₘ Jₘ]^{T} |
| 2 | set Vₖ^{I}(Iₘ, Jₘ) = 1 ∀m |
| 3 | set Vₖ^{I}(i, j) = 1 if Eₖ^{I}(i, j) = 1 |
| 4 | set Q(i, j) = Vₖ^{I}(i, j) |

Table 5 shows the relaxation stage 305.

TABLE 5
Steps of the Relaxation Stage

| RELAX | |
|---|---|
| STEP | Function |
| 1 | For i = 2 to N − 1, |
| 2 | For j = 2 to N − 1 |
| 3 | IF (i and j do not equal any of the Iₘ and Jₘ respectively), |
| | and (Eₖ^{I}(i, j) = 0) |
| | $\begin{matrix}{V}_{k}^{I} ( i , j ) = \frac{1}{4} ( {V}_{k}^{I} ( i - 1 , j ) + {V}_{k}^{I} ( i + 1 , j ) + \\ {V}_{k}^{I} ( i , j - 1 ) + {V}_{k}^{I} ( i , j + 1 ) )\end{matrix}$ |
| 4 | End |
| 5 | End |
| 6 | End |

Table 6 shows the scaling stage 308.

TABLE 6
Steps of the Scaling Stage

| SC | |
|---|---|
| STEP | Function |
| 1 | $compute \text{:} Vm = {min}_{i , j} {V}_{k}^{I} ( i , j )$ |
| 2 | $scale {V}_{k}^{I} ( i , j ) = \frac{{V}_{k}^{I} ( i , j ) - Vm}{1 - Vm}$ |

Table 7 shows the Field Convergence 310.

TABLE 7
Steps of the Field Convergence

| FC | |
|---|---|
| STEP | Function |
| 1 | if \|Vₖ^{I}(i, j) − Q(i, j)\| < ε₁ then convergence is reached |
| 2 | Else |
| | Q(i, j) = Vₖ^{I}(i, j) and action is routed back to the |
| | relaxation stage |

Table 8 shows the guidance stage 314.

TABLE 8
Steps Guidance Stage

| GS | |
|---|---|
| STEP | Function |
| 1 | $i = [ \frac{{x}_{k}}{Δx} ] , j = [ \frac{{y}_{k}}{Δy} ]$ |
| 2 | Gₖ^{I} = [Gxₖ^{I} Gyₖ^{I}]^{T} |
| 3 | Gxₖ^{I} = −(Vₖ^{I}(i + 1, j) − 2Vₖ^{I}(i, j) + Vₖ^{I}(i − 1, j)) |
| 4 | Gyₖ^{I} = −(Vₖ^{I}(i, j + 1) − 2Vₖ^{I}(i, j) + Vₖ^{I}(i, j − 1)) |
| 5 | C = \sqrt{Gxₖ^{I}^{²} + Gyₖ^{I}^{²}} |
| 6 | Gxₖ^{I} = Gxₖ^{I}/C, Gyₖ^{I} = Gyₖ^{I}/C |

Table 9 shows the motion generation, context change 316, and motion halt checks 318.

TABLE 9
Motion generation, Context change & Motion halt checks steps

| Halt | |
|---|---|
| Checks | Function |
| 1 | xt = xₖ, yt = yₖ |
| | xₖ = xt + s · Gxₖ^{I} |
| | yₖ = yt + s · Gyₖ^{I} |
| 2 | Procedure: keep monitoring Aₖ^{I} and Eₖ^{I}. If any significant |
| | change is detected (Aₖ^{I} ≠ Aₖ^{I} or Eₖ^{I} ≠ Eₖ^{I}), then updating |
| | motion is terminated and re-sensitization has to be carried |
| | out again using the new context |
| 3 | If \|xₖ − xt\| < ε₂ and \|yₖ − yt\| < ε₂ |
| | a. agent converged to desired location and agent stops |
| | b. Else, Keep updating trajectory (i.e., go to 1) |

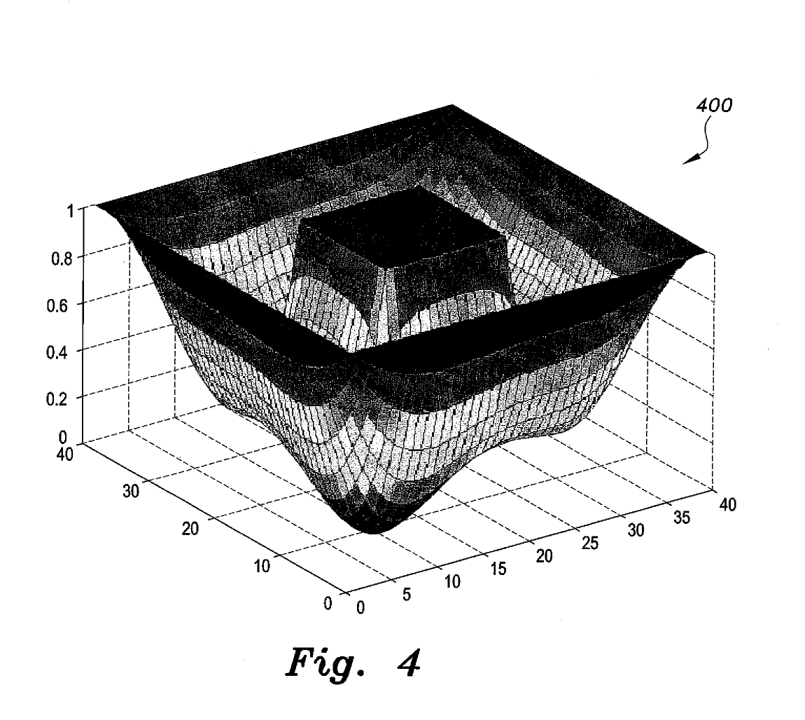

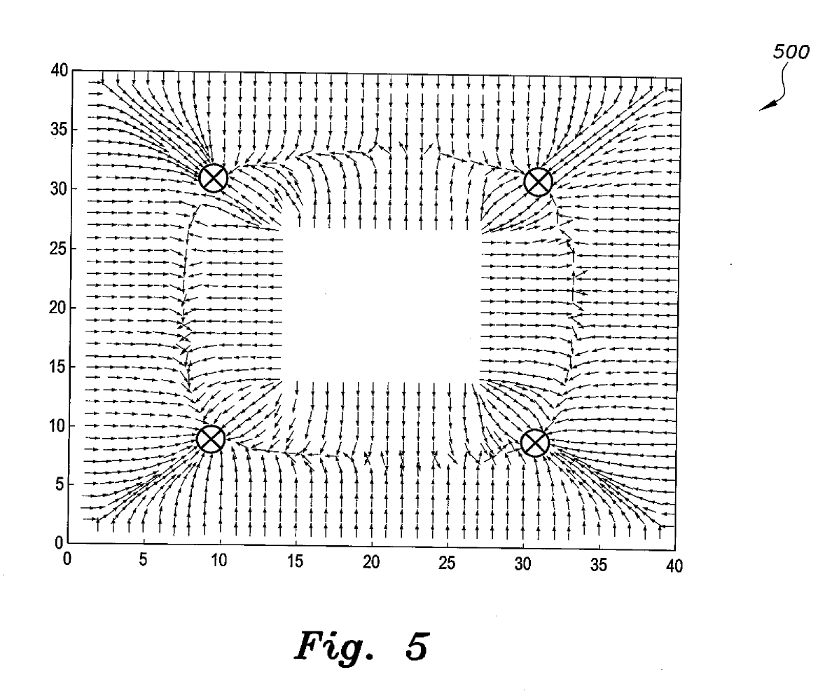

Testing of the capabilities of the structure is done using computer simulation. It should be understood by one of ordinary skill in the art that embodiments of the present multi-agent deployment protocol method can comprise software or firmware code executing on a computer, a microcontroller, a microprocessor, or a DSP processor; state machines implemented in application specific or programmable logic; or numerous other forms, and may be in operable communication with a robot for signal exchange between the processor, robotic drive components, robotic navigation components, and robotic sensor components without departing from the spirit and scope of the present invention. Moreover, the computer could be designed to be on-board the robot. The present multi-agent deployment protocol method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions. The vector guidance field is generated from an underlying scalar field. The generating scalar field 400 and guidance field 500 for an environment with a convex square obstacle that contains one agent only are shown in FIGS. 4 and 5. The crossed circles mark the four possible positions the agent could be steered to. As can be seen, all of these positions provide good line of sight coverage of free space. Also, notice that the target points are situated a safe distance away from the obstacles.

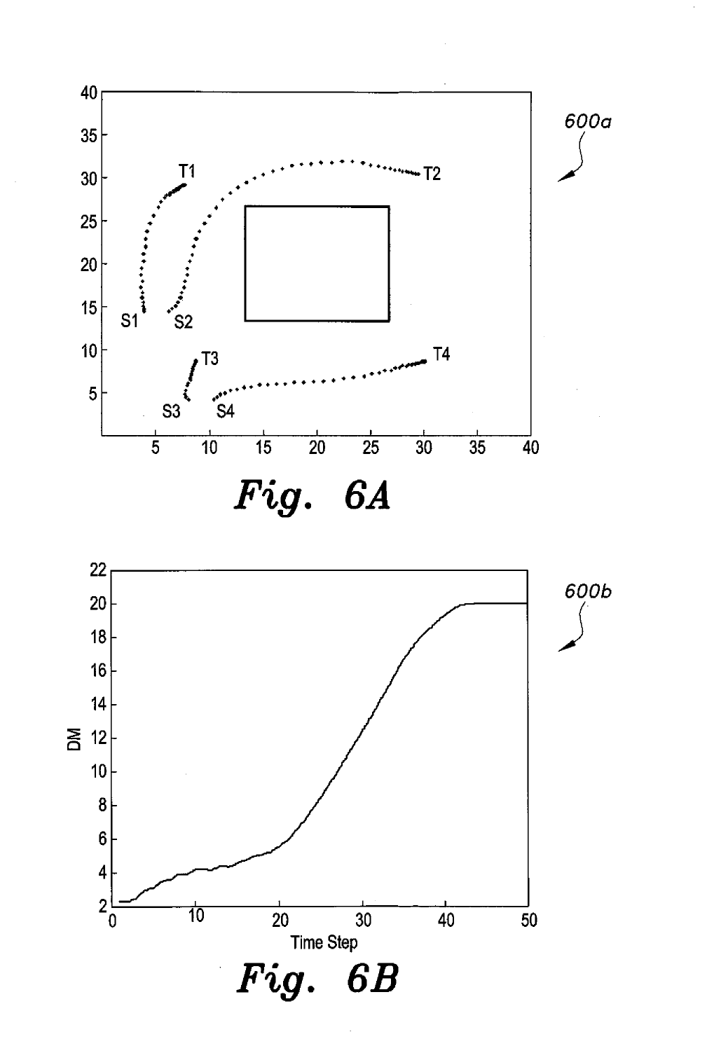

As shown in the plot 600a of FIG. 6A, four agents use the deployment protocol 500 illustrated in FIG. 5. Both trajectories (start points marked by Sᵢ, ends marked by Tᵢ) and minimum inter-agent distance (DM) (plot 600b of FIG. 6B) are shown. Each agent is aware of the position of all other agents sharing the space with it. As can be seen, starting from the initial positions, the agents were steered along well-behaved trajectories to locations where collectively they can observe the whole free space. The minimum inter-agent distance is non-zero for all times, which indicates that both self-collision and collision with obstacles are averted.

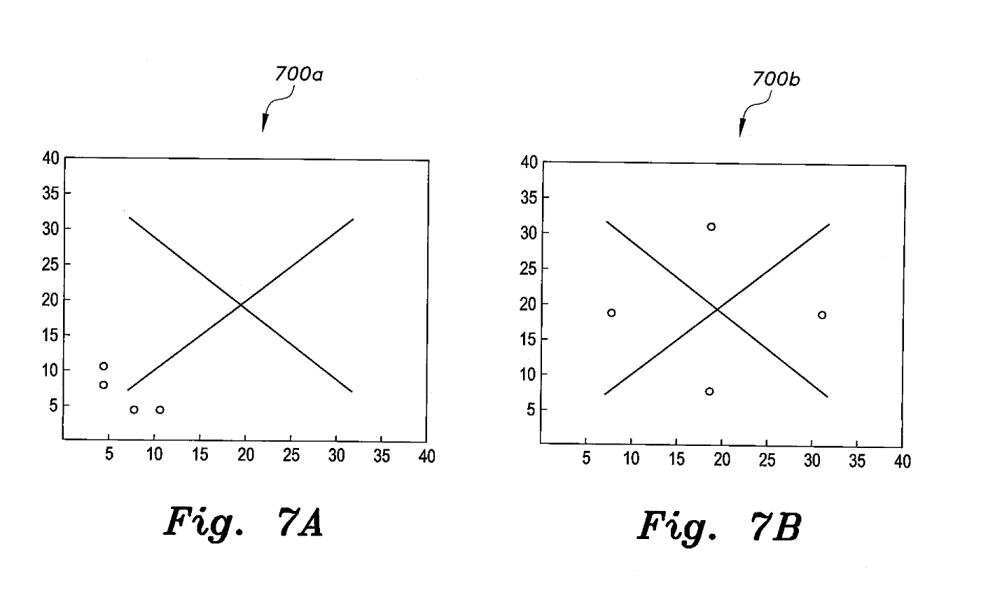

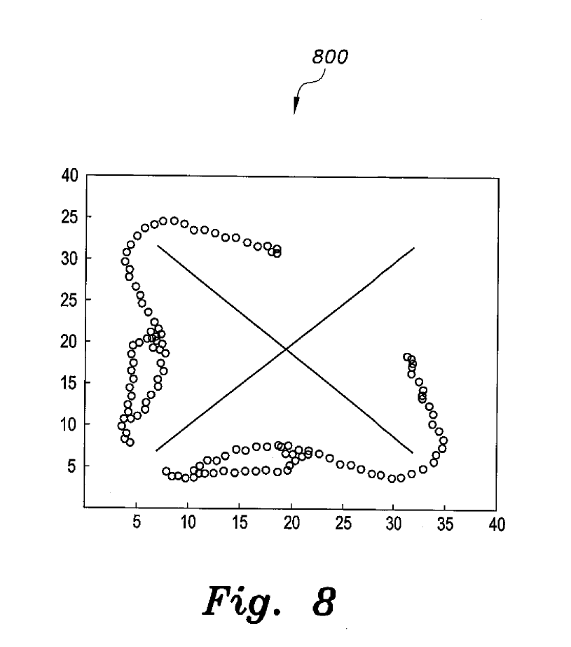

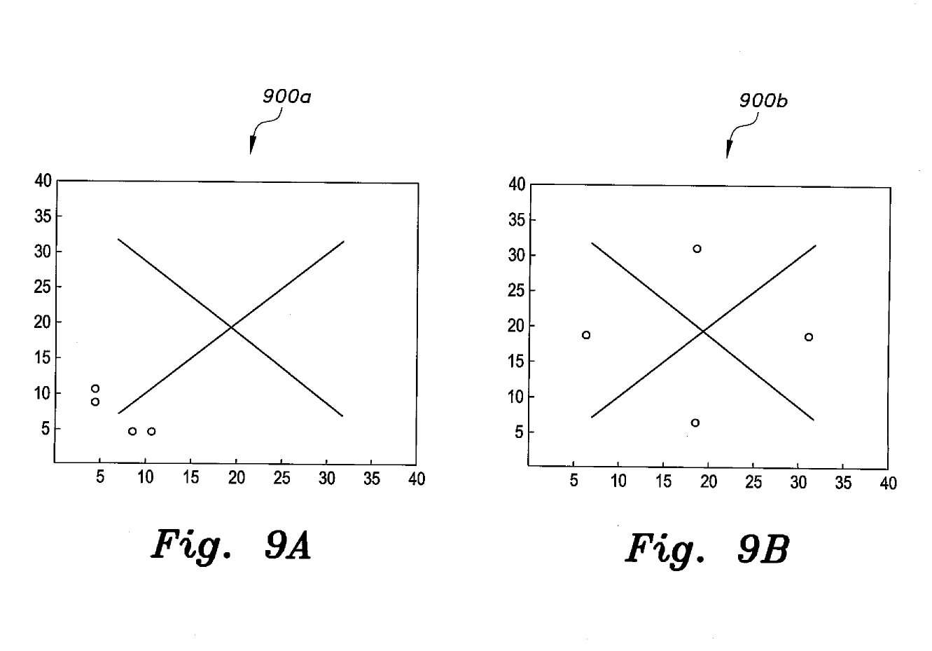

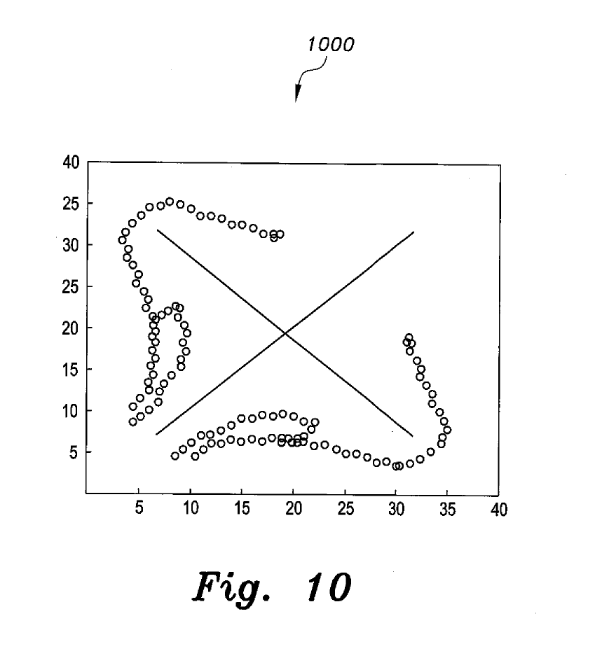

Plots 700a and 700b of FIGS. 7A and 7B, respectively, show the start and end positions of agents trying to position themselves in a challenging nonconvex environment. The agents are fully communicating with each other. As can be seen, the agents safely position themselves so that collectively they have a line of sight that can cover the whole environment. Plot 800 of FIG. 8 shows the corresponding trajectories the agents generated from start to end. As can be seen, the trajectories are well behaved. The above is repeated (plots 900a and 900b of FIGS. 9A and 9B, respectively, and plot 1000 of FIG. 10) when each agent is restricted to communicate to its only nearest neighbor. Similar behavior as in the full communication case is observed.

It is to be understood that the present invention is not limited to the embodiments described above, but encompasses any and all embodiments within the scope of the following claims.

I claim:

1. A multi-agent deployment protocol method for coverage of cluttered spaces, comprising the steps of:
(a) initializing each agent, its environment, and a locus of a convex or concave obstacle;
(b) for each agent, acquiring a context of the agent with respect to its environment, including other nearest neighbor agent positions;
(c) for each agent, sensitizing the agent by converting the agent's nearest neighbor positions to a discrete index;
(d) for each agent, performing a relaxed potential field computation to attempt to position the agent in a location where most free space is covered by the agent's line of sight;
(e) for each agent, scaling results of the relaxed potential field computation;
(f) for each agent, repeating the field computation step (d) and scaling step (e) until the field computation has converged;
(g) for each agent, updating a guidance vector;
(h) for each agent, summing the guidance vector of step (g) with a stored previous guidance vector of the agent;
(i) for each agent, updating motion commands;
(j) for each agent, checking for context change of nearest agent positions relative to said each agent's environment;
(k) for each agent, continue updating a trajectory by repeating steps (c) through (j) until there is no context change;
(l) for each agent, applying a stop signal when the agent has successfully converged to a desired location; and
(m) for each agent, storing the guidance vector as the stored previous guidance vector until the stop signal has been applied.

2. The multi-agent deployment protocol method according to claim 1, wherein processing of the multi-agent deployment protocol method is distributed among the agents.

3. The multi-agent deployment protocol method according to claim 2, further comprising the steps of:
executing said deployment protocol method processing in real-time; and
using sensors as inputs to said deployment protocol method processing.

4. The multi-agent deployment protocol method according to claim 2, wherein only a nearest neighbor of each of the agents is known to said each of the agents.

5. The multi-agent deployment protocol method according to claim 2, wherein processing of the multi-agent deployment protocol method continues among remaining agents when an agent is taken off-line.

6. The multi-agent deployment protocol method according to claim 1, wherein step (a) further comprises the steps of:
setting boundaries of a zone in which said agent is allowed to operate by setting discretization steps, including a discretization step Δx of an x component of space and a discretization step Δy of a y component of space;
setting a desired speed of the agent;
setting Vₖ^{I}(i, j)=0.5 for . . . all . . . i, j;
setting Vₖ^{I}(i, 0)=1, Vₖ^{I}(i, M)=1 i=1, . . . N; and
setting an initial location of the agent;
where i, j are the index of x and y components of space, respectively, Vₖ^{I}(i, j) is a matrix covering the space agent k is working in, Vₖ^{I}(i, 0) is the space covering matrix with an initial y component, Vₖ^{I}(i, M) is the space covering matrix with a final y component M, and where N is a final x component of Vₖ^{I}(i, j).

7. The multi-agent deployment protocol method according to claim 6, wherein step (b) further comprises the steps of:
obstacle sensing in the environment wherein the nearest neighbor positions are characterized by the relation Eₖ^{I}(i, j);
determining positions of Lₖ nearest agents characterized by the relation Aₖ^{I}, where Eₖ^{I}(i, j) is an environment description available to a k^{th} agent at interaction instant I, wherein an entry of 1 represents an obstacle and an entry of 0 represents free space, and Aₖ^{I} is a set containing the positions of the nearest Lₖ agents ordered according to their distance from agent k.

8. The multi-agent deployment protocol method according to claim 7, wherein step (c) further comprises the steps of:
converting the Aₖ^{I} into a discrete position index set DAₖ^{I}={DPₘ: m=1 . . . , Lₖ} where DPₘ=[Iₘ Jₘ]^{T};
setting Vₖ^{I}(Iₘ, Jₘ)=1 for . . . all . . . m;
setting Vₖ^{I}(i, j)=1 if Eₖ^{I}(i, j)=1; and
setting Q(i, j)=Vₖ^{I}(i, j),
where Q(i, j) is a temporary variable used to check convergence of Vₖ^{I}(i, j), and Aₖ^{I} is a set containing the positions of the nearest Lₖ agents ordered according to their distance from agent k.

9. The multi-agent deployment protocol method according to claim 8, wherein step (d) further comprises the step of relaxing the matrix when the agent's environment description indicates free space, wherein said matrix relaxation is characterized by the relation:
$${V}_{k}^{I} ( i , j ) = \frac{1}{4} ( {V}_{k}^{I} ( i - 1 , j ) + {V}_{k}^{I} ( i + 1 , j ) + {V}_{k}^{I} ( i , j - 1 ) + {V}_{k}^{I} ( i , j + 1 ) ) .$$

10. The multi-agent deployment protocol method according to claim 9, wherein step (e) further comprises the steps of:
computing
$$Vm = {min}_{i , j} {V}_{k}^{I} ( i , j ) ;$$
and
scaling Vₖ^{I}(i, j) according to a formula characterized by the relation:
$${V}_{k}^{I} ( i , j ) = \frac{{V}_{k}^{I} ( i , j ) - Vm}{1 - Vm} ,$$

11. The multi-agent deployment protocol method according to claim 10, wherein step (f) further comprises the steps of:
determining that convergence is reached if convergence criterion |Vₖ^{I}(i, j)−Q(i, j)|<ε₁; and
updating the temporary variable Q(i, j)=Vₖ^{I}(i, j) if convergence has not been reached, where ε₁ is an arbitrarily small positive constant used with the convergence criterion.

12. The multi-agent deployment protocol method according to claim 11, wherein step (g) further comprises the steps of:
computing
$$i = [ \frac{{x}_{k}}{Δ x} ] , \\ j = [ \frac{{y}_{k}}{Δ y} ] ;$$
computing Gₖ^{I}=[Gxₖ^{I} Gyₖ^{I}]^{T};
computing Gxₖ^{I}=−(Vₖ^{I}(i+1, j)−2Vₖ^{I}(i, j)+Vₖ^{I}(i−1, j));
computing Gyₖ^{I}=−(Vₖ^{I}(i, j+1)−2Vₖ^{I}(i, j)+Vₖ^{I}(i, j−1));
computing C=\sqrt{Gxₖ^{t}^{²}+Gyₖ^{I}^{²}}; and
computing Gxₖ^{I}=Gxₖ^{I}/C, Gyₖ^{I}=Gyₖ^{I}/C,
where G is a matrix used to store the guidance vector at each point in an agent's space.

13. The multi-agent deployment protocol method according to claim 12, wherein step (i) further comprises the steps of:
computing xt=xₖ, yt=yₖ;
computing xₖ=xt+s·Gxₖ^{I}; and
computing yₖ=yt+s·Gyₖ^{I},
where xt is an x direction command of the k^{th} agent, yt is a y direction command of the k^{th} agent, and s is a speed at which the agent is required to move.

14. The multi-agent deployment protocol method according to claim 13, wherein step (j) further comprises the step of monitoring Aₖ^{I} and Eₖ^{I} for a change such that (Aₖ^{I}≠Aₖ^{I}, Eₖ^{I}≠Eₖ^{I}).

15. A computer software product, comprising a non-transitory medium readable by a processor, the non-transitory medium having stored thereon a set of instructions implementing a multi-agent deployment protocol method for the coverage of cluttered spaces, the set of instructions including:
(a) a first sequence of instructions which, when executed by the processor, causes said processor to initialize each agent, its environment, and a locus of a convex or concave obstacle;
(b) a second sequence of instructions which, when executed by the processor, causes said processor to acquire for each agent a context of the agent with respect to its environment including other nearest neighbor agent positions;
(c) a third sequence of instructions which, when executed by the processor, causes said processor to sensitize said each agent by converting the agent's nearest neighbor positions to a discrete index;
(d) a fourth sequence of instructions which, when executed by the processor, causes said processor to perform for said each agent a relaxed potential field computation to attempt to position the agent in a location where most free space is covered by the agent's line of sight;
(e) a fifth sequence of instructions which, when executed by the processor, causes said processor to scale results of the relaxed potential field computation for each agent;
(f) a sixth sequence of instructions which, when executed by the processor, causes said processor to repeat for each agent the field computation instruction sequence (d) and scaling instruction sequence (e) until the field computation has converged;
(g) a seventh sequence of instructions which, when executed by the processor, causes said processor to update a guidance vector for each agent;
(h) an eighth sequence of instructions which, when executed by the processor, causes said processor to sum for each agent the guidance vector of instruction sequence (g) with a stored previous guidance vector of the agent;
(i) a ninth sequence of instructions which, when executed by the processor, causes said processor to update motion commands for each agent;
(j) a tenth sequence of instructions which, when executed by the processor, causes said processor to check for context change, for each agent, of nearest agent positions relative to said each agent's environment;
(k) a eleventh sequence of instructions which, when executed by the processor, causes said processor to continue updating a trajectory for each agent (repeating instruction sequences (c) through (j) until there is no context change;
(l) a twelfth sequence of instructions which, when executed by the processor, causes said processor to apply a stop signal for each agent when said each agent has successfully converged to a desired location; and
(m) a thirteenth sequence of instructions which, when executed by the processor, causes said processor to store for each agent the guidance vector as the stored previous guidance vector until the stop signal has been applied.

16. The computer software product according to claim 15, wherein the instruction sequences are distributed among the agents.

17. The computer software product according to claim 15, further comprising:
a fourteenth sequence of instructions which, when executed by the processor, causes said processor to execute said deployment protocol method in real-time; and
a fifteenth sequence of instructions which, when executed by the processor, causes said processor to use sensors as inputs to said deployment protocol method.

18. The computer software product according to claim 16, further comprising a sixteenth sequence of instructions which, when executed by the processor, causes said processor to process each of the agents, wherein only a nearest neighbor of said each of the agents is known to said each of the agents.

19. The computer software product according to claim 16, further comprising a seventeenth sequence of instructions which, when executed by the processor, causes said processor to continue executing the multi-agent deployment protocol method among remaining agents when an agent is taken off-line.

20. The computer software product according to claim 16, wherein the sequence of instructions (a) through (m) execute for each agent a control law characterized by the relation,
\dot{P}ₖ=F(Pₖ,Eₖ,Aₖ^{I}),
where \dot{P}ₖ is a time derivative of Pₖ, a position of a k^{th} agent in 2D space, Eₖ is an environment description available to the k^{th} agent, and Aₖ^{I} is a set containing positions of the nearest Lₖ agents ordered according to their distance from agent k.
